(19) United States
(12) Patent Application Publication
(10) Pub. No.: US 2010/0212847 A1
(43) Pub. Date: Aug. 26, 2010

(54) ANTI-FOAMING AGENT FOR THE PAPER INDUSTRY

(75) Inventors: Christoph Hamers, Ludwigshafen (DE); Klaus Lorenz, Worms (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/680,456

(22) PCT Filed: Oct. 13, 2008
(86) PCT No.: PCT/EP08/63701

§ 371 Date: Mar. 26, 2010

(30) Foreign Application Priority Data
Oct. 15, 2007 (EP) 07118448.5

(51) Int. Cl. D21C 3/28; B01D 19/04

(52) U.S. Cl. 162/75; 516/133

(57) ABSTRACT

Antifoams for the paper industry, based on oil-in-water emulsions in which the oil phase comprises

(a) at least one alcohol having at least 12 carbon atoms, fatty acid esters of alcohols having at least 22 carbon atoms and C₁- to C₃₆-carboxylic acids, distillation residues which are obtainable in the preparation of alcohols having a carbon number of at least 8 by oxo synthesis or by the Ziegler process and which, if appropriate, are alkoxylated, mixtures of said compounds and/or

(b) at least one fatty acid ester of C₁₂- to C₂₂-carboxylic acids with monohydric to trihydric C₁- to C₁₈-alcohols and, if appropriate,

(c) at least one hydrocarbon having a boiling point above 200° C. or a fatty acid having 12 to 22 carbon atoms and

(d) from 1 to 80% by weight of polyglyceryl esters which are obtainable by at least 20% esterification of polyglycerol mixtures comprising
from 0 to 10% by weight of monoglycerol,
from 15 to 40% by weight of diglycerol,
from 30 to 55% by weight of triglycerol,
from 10 to 25% by weight of tetraglycerol,
from 0 to 15% by weight of pentaglycerol,
from 0 to 10% by weight of hexaglycerol and
from 0 to 5% by weight of polyglycerols having a higher degree of condensation
   with at least one fatty acid having 12 to 36 carbon atoms, more than 50 to 80% by weight of the oil phase being involved in the production of the oil-in-water emulsions.

The invention relates to antifoams for the paper industry, based on oil-in-water emulsions in which the oil phase comprises at least one alcohol having at least 12 carbon atoms, fatty acid esters of alcohols having at least 22 carbon atoms and C₁- to C₃₆-carboxylic acids, distillation residues which are obtainable in the preparation of alcohols having a carbon number of at least 8 by oxo synthesis or by the Ziegler process and which, if appropriate, are alkoxylated, mixtures of said compounds and/or at least one fatty acid ester of C₁₂- to C₂₂-carboxylic acids with monohydric to trihydric C₁- to C₁₈-alcohols and, if appropriate, at least one hydrocarbon having a boiling point above 200° C. or a fatty acid having 12 to 22 carbon atoms and from 1 to 80% by weight of polyglyceryl esters which are obtainable by at least 20% esterification of polyglycerol mixtures comprising
from 0 to 10% by weight of monoglycerol,
from 15 to 40% by weight of diglycerol,
from 30 to 55% by weight of triglycerol,
from 10 to 25% by weight of tetraglycerol,
from 0 to 15% by weight of pentaglycerol,
from 0 to 10% by weight of hexaglycerol and
from 0 to 5% by weight of polyglycerols having a higher degree of condensation
with at least one fatty acid having 12 to 36 carbon atoms.

U.S. Pat. No. 4,950,420 discloses antifoams for the paper industry which comprise from 10 to 90% by weight of a surface-active polyether, such as polyoxyalkylated glycerol or polyalkoxylated sorbitol and from 10 to 90% by weight of a fatty acid ester of polyhydric alcohols, such as mono- and diesters of polyethylene glycol or polypropylene glycol. These antifoams are free of any oils, amides or water-repellent silica or silicone oils.

EP-A 0 149 812 discloses antifoams based on oil-in-water emulsions, in which the oil phase of the emulsion comprises

(a) a C₁₂- to C₂₆-alcohol, distillation residues which have been obtained in the preparation of alcohols having a relatively high carbon number by oxo synthesis or by the Ziegler process and, if appropriate, are also alkoxylated and/or

(b) a fatty acid ester of C₁₂- to C₂₂-carboxylic acids with a monohydric to trihydric C₁- to C₁₅-alcohol and, if appropriate,

(c) a hydrocarbon having a boiling point above 200° C. or fatty acids having 12 to 22 carbon atoms, has a mean particle size of from 0.5 to 15 μm and is involved in an amount of from 15 to 60% by weight in the production of the emulsion. The oil-in-water emulsions comprise, as a stabilizer, from 0.05 to 0.5% by weight of a high molecular weight, water-soluble homo- or copolymer of acrylic acid, methacrylic acid, acrylamide or methacrylamide.

JP-A 60/083559 and JP-A 61/227756 disclose the use of polyglyceryl fatty acid esters as foam suppressors in the production of foods, such as, for example, tofu. These formulations comprise no fatty alcohols; however, the presence of alkaline earth metal salts is essential. Antifoam formulations are known to have a good activity only in the area of use for which they have been developed, e.g. textile industry, food industry, paper industry, coating and leather industry. Owing to the specific activity, successful transfer or application of antifoams to other areas is not possible.

Antifoams based on oil-in-water emulsions, which are usually used in the production of paper, are known to lose activity if the temperature of the aqueous system to be defoamed increases above 35° C. At temperatures which are above 50° C., an even more rapid decline in the activity of the antifoams then occurs with the use of the known oil-in-water emulsions. Since the water circulations in the paper mills are more and more frequently closed circulations, this results in a temperature increase of the circulated water in papermaking, so that the activity of the antifoams used to date decreases substantially.

EP-A-0 322 830 discloses antifoams based on oil-in-water emulsions, in which the oil phase of the emulsions comprises:

(a) a C₁₂- to C₂₆-alcohol, distillation residues which are obtainable in the preparation of alcohols having a relatively high carbon number by oxo synthesis or by the Ziegler process and which, if appropriate, are also alkoxylated and/or

(b) a fatty acid ester of C₁₂- to C₂₂-carboxylic acids with a monohydric to trihydric C₁- to C₁₅-alcohol and, if appropriate,

(c) a hydrocarbon having a boiling point above 200° C. or fatty acids having 12 to 22 carbon atoms,

is involved in an amount of from 5 to 50% by weight in the production of the emulsion and has a mean particle size of <25 μm and in which from 5 to 50% by weight of the components (a) and (b) of the oil phase of the oil-in-water emulsion are replaced by

(d) at least one compound which melts at a temperature above 70° C. and is from the group consisting of the fatty alcohols having at least 28 carbon atoms, the esters of a C₁- to C₂₂-carboxylic acid with an alcohol having at least 28 carbon atoms, the adducts of C₂- to C₄-alkylene oxides with alcohols comprising at least 28 carbon atoms, the polyethylene waxes having a molecular weight of at least 2000 g/mol, the carnauba waxes, the montan ester waxes and the montanic acid waxes and the salts thereof.

The oil-in-water emulsions are effective antifoams in papermaking even at temperatures above 35° C., e.g. in the temperature range from 50 to 60° C.

EP-A 0 531 713 discloses antifoams based on oil-in-water emulsions, in which the oil phase of the emulsions is involved in an amount of from 5 to 50% by weight in the production of the emulsion and comprises the following constituents:

(a) an alcohol having at least 12 carbon atoms, fatty acid esters of alcohols having at least 22 carbon atoms and C₁- to C₃₆-carboxylic acids, distillation residues which are obtainable in the preparation of alcohols having a relatively high carbon number by oxo synthesis or by the Ziegler process and which, if appropriate, are also alkoxylated, mixtures of said compounds and/or

(b) a fatty acid ester of C₁₂- to C₂₂-carboxylic acids with a monohydric to trihydric C₁- to C₁₈-alcohol and, if appropriate,

(c) a hydrocarbon having a boiling point above 200° C. or fatty acids having 12 to 22 carbon atoms in combination with

(d) from 1 to 80% by weight of polyglyceryl esters which are obtainable by at least 20% esterification of polyglycerol mixtures comprising
from 0 to 10% by weight of monoglycerol,
from 15 to 40% by weight of diglycerol,
from 30 to 55% by weight of triglycerol,
from 10 to 25% by weight of tetraglycerol,
from 0 to 15% by weight of pentaglycerol,
from 0 to 10% by weight of hexaglycerol and
from 0 to 5% by weight of polyglycerols having a higher degree of condensation
   with at least one fatty acid having 12 to 36 carbon atoms. These antifoams are used for foam control in pulp digestion, the beating of paper stock, papermaking and the dispersing of pigments for papermaking in amounts of from 0.02 to 0.5 part by weight per 100 parts by weight of the foam-forming medium. In paper stocks, they also act as deaerators in the stated amounts.

It is the object of the present invention to provide for the paper industry further antifoams which, at temperatures of 40° C. or above, are at least as effective as the products used to date for this purpose.

The object is achieved, according to the invention, by antifoams for the paper industry, based on oil-in-water emulsions, in which the oil phase comprises

(a) at least one alcohol having at least 12 carbon atoms, fatty acid esters of alcohols having at least 22 carbon atoms and to C₁- to C₃₆-carboxylic acids, distillation residues which are obtainable in the preparation of alcohols having a carbon number of at least 8 by oxo synthesis or by the Ziegler process and which, if appropriate, are alkoxylated, mixtures of said compounds and/or

(b) at least one fatty acid ester of C₁₂- to C₂₂-carboxylic acids with monohydric to trihydric C₁- to C₁₈-alcohols and, if appropriate,

(c) at least one hydrocarbon having a boiling point above 200° C. or a fatty acid having 12 to 22 carbon atoms and

(d) from 1 to 80% by weight of polyglyceryl esters which are obtainable by at least 20% esterification of polyglycerol mixtures comprising
from 0 to 10% by weight of monoglycerol,
from 15 to 40% by weight of diglycerol,
from 30 to 55% by weight of triglycerol,
from 10 to 25% by weight of tetraglycerol,
from 0 to 15% by weight of pentaglycerol,
from 0 to 10% by weight of hexaglycerol and
from 0 to 5% by weight of polyglycerols having a higher degree of condensation
   with at least one fatty acid having 12 to 36 carbon atoms, if more than 50 to 80% by weight of the oil phase is involved in the production of the oil-in-water emulsions.

For example, from 51 to 80% by weight, preferably from 55 to 65% by weight, of the oil phase is involved in the production of the oil-in-water emulsions.

These antifoams are used for foam control in pulp digestion, the beating of paper stock, papermaking and the dispersing of pigments for papermaking in amounts of from 0.02 to 1.0 part by weight per 100 parts by weight of the foam-forming medium. In paper stocks, they also act as a deaerator in the stated amounts.

In particular, alcohols having at least 12 carbon atoms or mixtures of said alcohols are used as component (a) of the oil-in-water emulsions. These are as a rule monohydric alcohols which comprise up to 48 carbon atoms in the molecule. Such products are commercially available. However, it is also possible to use those fatty alcohols as component (a) which comprise a substantially larger number of carbon atoms in the molecule. The alcohols of component (a) are either natural or synthetic alcohols. For example, lauryl alcohol, myristyl alcohol, cetyl alcohol, palmityl alcohol, stearyl alcohol, behenyl alcohol, oleyl alcohol, ricinolyl alcohol, linoleyl alcohol and erucyl alcohol are suitable.

Mixtures of alcohols having different numbers of carbon atoms may also be used as component (a), for example mixtures of (1) alcohols having 12 to 26 carbon atoms and (2) alcohols having 28 to 48 carbon atoms.

The synthetic alcohols of component (a) have at least 8, in general at least 10, carbon atoms in the molecule. They are obtainable, for example, by the Ziegler process by oxidation of alkylaluminums. These are saturated, straight-chain, unbranched alcohols. Synthetic alcohols having more than 8 carbon atoms in the molecule are also obtained by oxo synthesis. As a rule, alcohol mixtures are obtained thereby. Distillation residues which are obtained in the preparation of the abovementioned alcohols by oxy synthesis or by the Ziegler process can also be used as component (a) of the oil phase of the antifoam emulsions. The distillation residues are substantially alcohols having a boiling point of at least 200° C. at a pressure of 20 mbar.

Alkoxylated distillation residues which are obtained in the abovementioned process for the preparation of higher alcohols by oxo synthesis or by the Ziegler process are also suitable as constituent (a) of the oil phase of the antifoam emulsions. The oxyalkylated distillation residues are obtained by subjecting the distillation residues to the alkoxylation with ethylene oxide or with propylene oxide or with a mixture of ethylene oxide and propylene oxide by known processes. Up to 5 ethylene oxide or propylene oxide groups undergo addition per OH group of the alcohol in the distillation residue. Preferably, from 1 to 2 ethylene oxide groups undergo addition per OH group of the alcohol in the distillation residue.

Fatty acid esters of alcohols having at least 22 carbon atoms and C₁- to C₃₆-carboxylic acids, e.g. montan waxes or carnauba waxes, are also suitable as component (a).

The abovementioned compounds of component (a) can form the oil phase of the oil-in-water emulsions either alone or as a mixture with one another in any desired ratios as a constituent of component (a).

Fatty acid esters of C₁₂- to C₂₂-carboxylic acids with a monohydric to trihydric C₁- to C₁₈-alcohol are used as component (b) of the oil phase of the antifoam emulsion. The fatty acids on which the esters are based are, for example, lauric acid, myristic acid, palmitic acid, stearic acid, arachidic acid and behenic acid. Palmitic acid or stearic acid is preferably used for the preparation of the esters. It is possible to use monohydric C₁- to C₁₈-alcohols for the esterification of said carboxylic acids, e.g. methanol, ethanol, propanol, butanol, hexanol, decanol and stearyl alcohol, as well as dihydric alcohols, such as ethylene glycol or trihydric alcohols, such as glycerol. The polyhydric alcohols may be completely or partly esterified.

The oil phase of the emulsion may additionally comprise a further class of water-insoluble compounds which are referred to below as component (c). Up to 50% by weight, based on the components (a) and (b), of the compounds of component (c) may be involved in the production of the oil phase of the antifoam emulsions. They may be added either to a mixture of the components (a) and (b) or to each of the compounds mentioned under (a) or (b). For example, hydrocarbons having a boiling point of more than 200° C. at 1013 mbar and a pour point below 0° C. or fatty acids having 12 to 22 carbon atoms are suitable as component (c). Preferably, the liquid paraffins, such as the commercially available paraffin mixtures, which are also referred to as white oil, are suitable as hydrocarbons.

The components (a) and (b) can be used in any desired ratio for the preparation of the antifoam emulsions. Each of these two components may be present either alone or as a mixture with the other in the antifoams according to the invention. In practice, for example, mixtures of (a) and (b) which comprise from 40 to 60% by weight of the component (a) and from 60 to 40% of the component (b) have proven useful. The oil phase of the oil-in-water emulsions can, if appropriate, additionally comprise at least one compound (c). However, what is important is that at least one of the abovementioned components (a) or (b) in combination with at least one compound of the group (d) mentioned below forms the oil phase of the oil-in-water emulsions.

The compounds (d) are involved in the production of the oil phase of the oil-in-water emulsions in an amount of from 1 to 80, preferably from 5 to 20, % by weight. This means that the oil phase of the antifoam emulsions necessarily comprises the following combinations: (a) and (d), (b) and (d), and (a), (b) and (d). The compounds of the component (c) can, if appropriate, be used in all three abovementioned combinations of the composition of the oil phase in amounts up to 40% by weight, based on the oil phase of the oil-in-water emulsions. Suitable components (d) of the oil phase are polyglyceryl esters which are obtainable by at least 20% esterification of polyglycerol mixtures comprising:
from 0 to 10% by weight of glycerol,
from 15 to 40% by weight of diglycerol,
from 30 to 55% by weight of triglycerol,
from 10 to 25% by weight of tetraglycerol,
from 0 to 15% by weight of pentaglycerol,
from 0 to 10% by weight of hexaglycerol and
from 0 to 5% by weight of polyglycerols having a higher degree of condensation
with at least one fatty acid having 12 to 36 carbon atoms in the molecule.

The polyglycerol mixtures described above are preferably esterified with fatty acids comprising 16 to 30 carbon atoms. The degree of esterification is from 20 to 100, preferably from 60 to 100, %. The fatty acids suitable for the esterification of the polyglycerol mixtures may be saturated fatty acids as well as unsaturated fatty acids. Fatty acids suitable for the esterification of the polyglycerol mixtures are, for example, lauric acid, myristic acid, palmitic acid, stearic acid, arachidic acid, behenic acid and montan wax acids. Ethylenically unsaturated fatty acids, e.g. oleic acid, hexadecenoic acids, elaidic acid, eicosenoic acids and docosenoic acids, such as erucic acid or brassidic acid, and polyunsaturated acids, such as octadecenedienoic acids and octatrienoic acids, such as linoleic acid and linolenic acid, and mixtures of said saturated and unsaturated carboxylic acids are also suitable for the esterification of the polyglycerol mixtures.

The polyglycerol mixtures are obtainable, for example, by alkali-catalyzed condensation of glycerol at elevated temperatures (cf. for example Fette, Seifen, Anstrichmittel, 88th year, No. 3, pages 101 to 106 (1986) or according to DE-A 38 42 692) or by reaction of glycerol with epichlorohydrin in the presence of acidic catalysts at elevated temperatures. However, the mixtures are also obtainable by mixing the pure polyglycerol components, e.g. diglycerol, triglycerol and tetraglycerol, with one another. The polyglycerol mixtures esterified to a degree of at least 20% are prepared by esterification of the polyglycerol mixtures with the desired fatty acid or mixture of fatty acids by known processes. As a rule, the procedure is effected here in the presence of an acidic esterification catalyst, such as sulfuric acid, p-toluenesulfonic acid, methanesulfonic acid, citric acid, phosphorous acid, phosphoric acid, hypophosphorous acid, or basic catalysts, such as sodium methylate or potassium tert-butylate.

The compounds of component (d) are present in an amount of from 1 to 80, preferably from 5 to 20, % by weight in the oil phase. According to the invention, more than 50 to 80% by weight of the oil phase is involved in the production of the oil-in-water emulsions, while the proportion of the aqueous phase in the production of the emulsions is less than 50 to 20% by weight, the percentages by weight summing in each case to 100.

The oil phase is emulsified into the aqueous phase. For example, apparatuses in which the components of the emulsion are subjected to a steep shear gradient, e.g. dispersers, are required for this purpose. In order to obtain particularly stable oil-in-water emulsions, the emulsification of the oil phase in the aqueous phase is preferably carried out in the presence of surface-active substances which have an HLB value of more than 6 (for the definition of the HLB value, cf. W. C. Griffin, Journal of the Society of Cosmetic Chemists, volume 5, pages 249 to 256 (1954)). The surface-active substances are oil-in-water emulsifiers or typical wetting agents. Among the surface-active substances, anionic, cationic or nonionic compounds may be used or mixtures of these compounds which are compatible with one another, for example mixtures of anionic and nonionic or cationic and nonionic wetting agents. Substances of said type are, for example, sodium or ammonium salts of higher fatty acids, such as ammonium oleate or ammonium stearate, oxyalkylated alkylphenols, such as nonylphenol or isooctylphenol, which are reacted in a molar ratio of from 1:2 to 1:50 with ethylene oxide, oxyethylated unsaturated oils, e.g. the reaction products of one mole of castor oil and from 30 to 40 mol of ethylene oxide or the reaction products of one mole of sperm alcohol with from 60 to 80 mol of ethylene oxide. Sulfonated oxyethylation products of nonylphenol or octylphenol, which are present as the sodium or ammonium salt of the corresponding sulfuric acid monoester, are also preferably used as emulsifiers.

100 parts by weight of the oil-in-water emulsions usually comprise from 0.1 to 5 parts by weight of an emulsifier or of an emulsifier mixture. In addition to the abovementioned emulsifiers, it is also possible to use protective colloids, such as high molecular weight polysaccharides and soaps, or other customary additives, such as stabilizers, in the preparation of the oil-in-water emulsions. Thus, for example, an addition of from 0.05 to 0.5% by weight, based on the total emulsion, of high molecular weight, water-soluble homo- and copolymers of acrylic acid, methacrylic acid, acrylamide or methacrylamide, has proven useful as a stabilizer. The use of such stabilizers is, for example, the subject of EP-A 0 149 812. By emulsifying the oil phase in the aqueous phase, oil-in-water emulsions which, immediately after the preparation, have a viscosity in the range of, for example, from 300 to 3000 mPa·s and which have a mean particle size of the oil phase of less than 25 μm, preferably in the range from 0.5 to 15 μm, are obtained.

Although the compounds of component (d), alone or as a mixture with the component (c), have virtually no activity as oil-in-water emulsion antifoams, a synergistic effect surprisingly occurs on combination of a compound of the component (d) with compounds (a) and/or (b), which synergistic effect is most pronounced in the case of the combination of (a) with (d) and (a) with (b) and (d).

The addition of the component (d) to the oil phase of antifoams which comprise the component (a) and/or (b) and, if appropriate, even further constituents in emulsified form does not adversely affect or only slightly adversely affects the activity of the antifoams thus obtainable at relatively low temperatures, e.g. at room temperature, but increases the activity of these antifoams in aqueous systems whose temperature is above 40° C. to an unexpected extent.

The oil-in-water emulsions according to the invention are used in the paper industry in aqueous systems in which the formation of foam at relatively high temperatures must be controlled, e.g. during pulp digestion, the beating of paper stock, papermaking with closed water circulations of paper machines and the dispersing of pigments for papermaking. Based on 100 parts by weight of paper stock in a foam-forming medium, from 0.02 to 1.0, preferably from 0.05 to 0.3, part by weight of the oil-in-water antifoam emulsion is used. Moreover, on addition to a paper stock suspension, the antifoams result in deaeration and are therefore also used as deaerators in papermaking (addition to the paper stock). They are also suitable as antifoams in paper coating, where they are added to paper coating slips. The antifoams can also be used in the food industry and the starch industry and in wastewater treatment plants for foam control. If they are added as a deaerator to the paper stock, the amounts used for this purpose are from 0.02 to 0.5 part by weight per 100 parts by weight of paper stock.

The higher content of oil phase in the case of the oil-in-water emulsions according to the invention compared with the emulsions disclosed in EP-A-0 531 713 leads to more efficient products. In comparison with the known products, these products have the advantage that it is possible to manage with smaller amounts of product during use. Moreover, the transport costs for the oil-in-water emulsions according to the invention are lower than for the known ones.

### EXAMPLES

The parts stated in the examples are parts by weight. The stated percentages are based on the weight of the substances, unless evident otherwise from the context.

The mean particle size of the particles of the oil phase which were emulsified in water was determined with the aid of a Coulter counter from Beckmann.

The K value of polymers was measured according to H. Fikentscher, Cellulose-Chemie, volume 13, 58 to 64 and 71 to 74 (1932), in aqueous solution at a temperature of 25° C. and a concentration of 0.5% by weight at pH 7.

Determination of the air content (average %):

In each case 10 l of a 0.1% (groundwood) foam-developing paper stock suspension was circulated for 5 minutes by pumping in a container made of transparent plastic. The amount of air formed in the stock suspension was then determined with the aid of an air-measuring apparatus (e.g. based on the impedance method, as in the case of the Sonica apparatus from Conrex, or based on sound velocity measurement, as in the case of the Sonatrac from Cidra). For assessing the activity of an antifoam, the average air content was stated 5 minutes after the addition of a deaerator. If the paper stock suspension is circulated by pumping in the absence of an antifoam for 5 minutes, an average air content of 6% is obtained. By the addition of in each case 5 mg/l of an effective antifoam to the paper stock suspension, this value is substantially reduced, so that it is a measure of the activity of an antifoam.

Testing of the antifoams: the temperature of the paper stock suspension was 30, 40, 50 or 60° C., depending on the test, the temperature being kept constant within ±1° C. during the 5 minute test. In this terminology, the antifoam is all the more effective the lower the average air content of the paper stock suspension.

### Example 1

An oil-in-water emulsion in which the oil phase was involved in an amount of 60% by weight in the production of the emulsion and had a mean particle size of from 3 to 10 μm was prepared with the aid of a disperser. The oil phase consisted of the following components:

(a) 21 parts of a fatty alcohol mixture of C₁₂- to C₂₆-alcohols

(b) 5 parts of glyceryl triester of C₁₆- to C₁₈-fatty acids

(c) 1 part of a mineral oil (commercially available white oil) and

(d) 2 parts of a polyglyceryl ester which is obtainable by esterification of a polyglycerol mixture comprising
27% of diglycerol,
44% of triglycerol,
19% of tetraglycerol and
10% of polyglycerols having a higher degree of condensation

with a C₁₂- to C₂₆-fatty acid mixture. The degree of esterification was 60%.

The water phase consisted of:

65 parts of water,

3 parts of an emulsifier which is obtainable by an addition reaction of 25 mol of ethylene oxide with 1 mol of isooctylphenol and esterification of the adduct with sulfuric acid to give the monoester,

1 part of a copolymer of 70% of acrylamide and 30% of acrylic acid, having a K value of 270, and

0.2 part of sodium hydroxide solution.

The components (a) to (d) were first heated to a temperature of 110° C. and then added to the aqueous phase heated to 80° C., with dispersion. The oil-in-water emulsion thus obtainable had a viscosity of 1550 mPa·s at a temperature of 20° C. immediately after the preparation. The activity of this antifoam emulsion was tested as described above on a paper stock suspension. The results are stated in the table.

### Comparative Example 1 a (Comparison with EP-A 0 531 713)

An oil-in-water emulsion in which the oil phase was involved in an amount of 30% by weight in the production of the emulsion and had a mean particle size of from 3 to 10 μm was prepared with the aid of a disperser. The oil phase consisted of the following components:

(a) 21 parts of a fatty alcohol mixture of C₁₂- to C₂₆-alcohols

(b) 5 parts of glyceryl triester of C₁₆- to C₁₈-fatty acids

(c) 1 part of a mineral oil (commercially available white oil) and

(d) 2 parts of a polyglyceryl ester which is obtainable by esterification of a polyglycerol mixture comprising
27% of diglycerol,
44% of triglycerol,
19% of tetraglycerol and
10% of polyglycerols having a higher degree of condensation

with a C₁₂- to C₂₆-fatty acid mixture. The degree of esterification was 60%.

The water phase consisted of:

65 parts of water,

3 parts of an emulsifier which is obtainable by an addition reaction of 25 mol of ethylene oxide with 1 mol of isooctylphenol and esterification of the adduct with sulfuric acid to give the monoester,

1 part of a copolymer of 70% of acrylamide and 30% of acrylic acid, having a K value of 270, and

0.2 part of sodium hydroxide solution.

The components (a) to (d) were first heated to a temperature of 110° C. and the aqueous phase heated to 80° C. was then added, with dispersion. The oil-in-water emulsion thus obtainable had a viscosity of 2850 mPa·s at a temperature of 20° C. immediately after the preparation. The activity of this antifoam emulsion was tested as described above on a paper stock suspension. The results are stated in the table.

### Comparative Example 1 b

An oil-in-water emulsion was prepared by the method stated in example 1 a, except that the component (d) was omitted and the proportion of the fatty alcohol mixture of component (a) was increased to 23 parts. An emulsion whose viscosity immediately after preparation was 340 mPa·s at 20° C. was obtained. The activity of this antifoam emulsion was tested as described above on a paper stock suspension. The results are stated in the table.

### Comparative Example 1 c

An oil-in-water emulsion was prepared by the method stated in example 1 a, except that the component (d) was omitted and the proportion of the fatty alcohol mixture of component (a) was increased to 23 parts and the total proportion of oil was adjusted to 30%. An emulsion whose viscosity immediately after preparation was 540 mPa·s at 20° C. was obtained. The activity of this antifoam emulsion was tested as described above on a paper stock suspension. The results are stated in the table.

### Example 2

An emulsion was prepared by the method stated in example 1 a, the aqueous phase according to example 1 a remaining unchanged and the oil phase of the antifoam having the following composition:

(a) 22.0 parts of a fatty alcohol mixture comprising C₁₂- to C₂₆-alcohols,

(b) 6.2 parts of a glyceryl triester of C₁₆- to C₁₈-fatty acids and

(c) 2 parts of a polyglyceryl ester which was prepared by esterification of a polyglycerol mixture comprising
27% of diglycerol,
44% of triglycerol,
19% of tetraglycerol and
10% of polyglycerols having a higher degree of condensation
   with a montan wax acid in the ratio 1:3. The degree of esterification was 60%. The viscosity of this emulsion immediately after the preparation was 1630 mPa·s. The testing of the emulsion as an antifoam was effected by the method described above and gave the value stated in the table.

### Comparative Example 2 (Comparison with EP-A 0 531 713)

An emulsion was prepared by the method stated in comparative example 1 a, the aqueous phase according to comparative example 1 a remaining unchanged and the oil phase of the antifoam having the following composition:

(a) 22.0 parts of a fatty alcohol mixture comprising C₁₂- to C₂₆-alcohols,

(b) 6.2 parts of a glyceryl triester of C₁₆- to C₁₈-fatty acids and

(c) 2 parts of a polyglyceryl ester which was prepared by esterification of a polyglycerol mixture comprising
27% of diglycerol,
44% of triglycerol,
19% of tetraglycerol and
10% of polyglycerols having a higher degree of condensation
   with a montan wax acid in the ratio 1:3. The degree of esterification was 60%. The viscosity of this emulsion immediately after the preparation was 2930 mPa·s. The testing of the emulsion as an antifoam was effected by the method described above and gave the value stated in the table.

### Example 3

An emulsion was prepared by the method stated in example 2, the aqueous phase according to example 1 a remaining unchanged and the oil phase of the antifoam having the following composition:

(a) 22.0 parts of a fatty alcohol mixture comprising C₁₂- to C₂₆-alcohols,

(b) 6.2 parts of a glyceryl triester of C₁₆- to C₁₈-fatty acids and

(c) 2 parts of polyglyceryl ester which is obtainable by esterification of a polyglycerol mixture comprising
27% of diglycerol,
44% of triglycerol,
19% of tetraglycerol and
10% of polyglycerols having a higher degree of condensation
   with a C₂₂-fatty acid in the weight ratio 1:2 and had a degree of esterification of 40%.

The viscosity of this emulsion immediately after the preparation was 660 mPa·s. The emulsion was tested as an antifoam by the method described above. The results are stated in the table.

### Comparative Example 3

An emulsion was prepared by the method stated in comparative example 2, the aqueous phase according to example 1 remaining unchanged and the oil phase of the antifoam having the following composition:

(a) 22.0 parts of a fatty alcohol mixture comprising C₁₂- to C₂₆-alcohols,

(b) 6.2 parts of a glyceryl triester of C₁₆- to C₁₈-fatty acids and

(c) 2 parts of polyglyceryl ester which is obtainable by esterification of a polyglycerol mixture comprising
27% of diglycerol,
44% of triglycerol,
19% of tetraglycerol and
10% of polyglycerols having a higher degree of condensation
   with a C₂₂-fatty acid in the weight ratio 1:2 and had a degree of esterification of 40%. The viscosity of this emulsion immediately after the preparation was 660 mPa·s. The emulsion was tested as an antifoam by the method described above. The results are stated in the table.

TABLE

| | | | | Viscosity | Viscosity |
|---|---|---|---|---|---|
| Oil-in- | 30° C. | 50° C. | 60° C. | immediately | after 1 week |
| water emulsion according to | av. % | av. % | av. % | mPa · s | mPa · s |
| Example 1 | 0.3 | 0.15 | 0.3 | 1550 | 2000 |
| Comparative example 1 a | 0.6 | 0.3 | 0.6 | 2850 | 3000 |
| Comparative example 1 b | 0.3 | 0.5 | 0.6 | 340 | 800 |
| Comparative example 1 c | 0.5 | 0.9 | 1.2 | 540 | 800 |
| Example 2 | 0.3 | 0.2 | 0.3 | 1630 | 4500 |
| Comparative example 2 | 0.6 | 0.3 | 0.6 | 2930 | 4000 |
| Example 3 | 0.3 | 0.2 | 0.3 | 660 | 1200 |
| Comparative example 3 | 0.5 | 0.4 | 0.7 | 660 | 1500 |

av. %: average air content of the stock suspension in percent, determined by the abovementioned method.

We claim:

1. An antifoam for the paper industry, based on oil-in-water emulsions in which the oil phase comprises
(a) at least one alcohol having at least 12 carbon atoms, fatty acid esters of alcohols having at least 22 carbon atoms and C₁- to C₃₆-carboxylic acids, distillation residues which are obtainable in the preparation of alcohols having a carbon number of at least 8 by oxo synthesis or by the Ziegler process and which, if appropriate, are alkoxylated, mixtures of said compounds and/or
(b) at least one fatty acid ester of C₁₂- to C₂₂-carboxylic acids with monohydric to trihydric C₁- to C₁₈-alcohols and, if appropriate,
(c) at least one hydrocarbon having a boiling point above 200° C. or a fatty acid having 12 to 22 carbon atoms and
(d) from 1 to 80% by weight of polyglyceryl esters which are obtainable by at least 20% esterification of polyglycerol mixtures comprising
from 0 to 10% by weight of monoglycerol,
from 15 to 40% by weight of diglycerol,
from 30 to 55% by weight of triglycerol,
from 10 to 25% by weight of tetraglycerol,
from 0 to 15% by weight of pentaglycerol,
from 0 to 10% by weight of hexaglycerol and
from 0 to 5% by weight of polyglycerols having a higher degree of condensation
with at least one fatty acid having 12 to 36 carbon atoms, wherein more than 50 to 80% by weight of the oil phase is involved in the production of the oil-in-water emulsions.

2. The use of the antifoam according to claim 1 for controlling foam in pulp digestion, the beating of paper stock, papermaking and the dispersing of pigments for papermaking in amounts of from 0.02 to 1.0 part by weight per 100 parts by weight of the foam-forming medium.

3. The use of the antifoam according to claim 1 as a deaerator in paper stocks in amounts of from 0.02 to 0.5 part by weight per 100 parts by weight of the paper stocks.
